(19) United States
(12) Patent Application Publication
(10) Pub. No.: US 2025/0106031 A1
(43) Pub. Date: Mar. 27, 2025

(54) SYSTEM AND METHOD FOR DECENTRALIZED DIGITAL IDENTITY VERIFICATION

(71) Applicants: Rahul Parthe, Bloomfield Hills, MI (US); Vishesh Mistry, Alpharetta, GA (US); Debayan Deb, Bloomfield Hills, MI (US)

(72) Inventors: Rahul Parthe, Bloomfield Hills, MI (US); Vishesh Mistry, Alpharetta, GA (US); Debayan Deb, Bloomfield Hills, MI (US)

(21) Appl. No.: 18/658,621

(22) Filed: May 8, 2024

Related U.S. Application Data
(60) Provisional application No. 63/452,057, filed on Mar. 14, 2023.

(51) Int. Cl. H04L 9/32; H04L 9/00; H04L 9/08

(52) U.S. Cl. CPC H04L 9/3231; H04L 9/0819; H04L 9/50

(57) ABSTRACT

A system for an automated real-time digital identity verification based on live biometric data including a processor of an identity verification node connected to at least one verifier entity node over a network and a memory on which are stored machine-readable instructions that when executed by the processor, cause the processor to: acquire a request associated with a user cryptograph embedded into an identification user credential from the at least one verifier entity node, wherein the identity verification request including at least one live biometric data sample captured by the at least one verifier entity node and at least one parameter indicating a piece of data from the user cryptograph to be revealed to the at least one verifier entity; generate a stable bio-hash from the at least one live biometric data sample; derive the at least one parameter from the request; generate a decryption key comprising a plurality of shards from the at least one live biometric data sample; and provide at least one of the plurality of shards to the at least one verifier entity node based on the at least one parameter.

### FIELD OF DISCLOSURE

The present disclosure generally relates to use and verification of digital identities, and more particularly, to an automated system for digital identity verification based on user credential and associated identity binding using biometrics in a decentralized fashion in an offline or online manner.

### BACKGROUND

Identity has become a vital part of human life as it allows people to participate in society. Identity verification allows humans to either avail of services or contribute to the development of society. There are three actors in an identity life cycle: an authority that issues a credential to a person or entity that can be checked for authenticity and identity binding; verifying or relying party that needs to verify the credential before offering a service and a carrier/owner who carries the issued credential and presents it to a verifying or relying party.

There are several conventional ways of issuing credentials, carrying, and verifying them. The efficacy of the system depends on the ease of issuance and provisioning, carrying and presenting, and the ease of verification. This frictionless usage must be achieved without compromising the security and privacy aspect of the process. Current existing identity credential issuance and verification systems have the following shortcomings. Systems that rely on physical credentials such as plastic cards with chips require purpose-built devices for verification. System that relies on mobile phones for credential storage makes it necessary for the identity carrier to have a phone. Systems that are based on a centralized system or backend have a dependency on internet connection to function.

Accordingly, an automated method and system for digital identity verification based on user credential and associated identity binding using biometrics in a decentralized fashion in an offline or online manner are desired.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

One embodiment of the present disclosure provides a system for an automated real-time digital identity verification based on live biometric data including a processor of an identity verification node connected to at least one verifier entity node over a network and a memory on which are stored machine-readable instructions that when executed by the processor, cause the processor to: acquire a request associated with a user cryptograph embedded into an identification user credential from the at least one verifier entity node, wherein the identity verification request including at least one live biometric data sample captured by the at least one verifier entity node and at least one parameter indicating a piece of data from the user cryptograph to be revealed to the at least one verifier entity; generate a stable bio-hash from the at least one live biometric data sample; derive the at least one parameter from the request; generate a decryption key comprising a plurality of shards from the at least one live biometric data sample; and provide at least one of the plurality of shards to the at least one verifier entity node based on the at least one parameter.

Another embodiment of the present disclosure provides a method that includes one or more of: acquiring a request associated with a user cryptograph embedded into an identification user credential from the at least one verifier entity node, wherein the identity verification request including at least one live biometric data sample captured by the at least one verifier entity node and at least one parameter indicating a piece of data from the user cryptograph to be revealed to the at least one verifier entity; generate a stable bio-hash from the at least one live biometric data sample; deriving the at least one parameter from the request; generate a decryption key comprising a plurality of shards from the at least one live biometric data sample; and providing at least one of the plurality of shards to the at least one verifier entity node based on the at least one parameter.

Another embodiment of the present disclosure provides a computer-readable medium including instructions for acquiring a request associated with a user cryptograph embedded into an identification user credential from the at least one verifier entity node, wherein the identity verification request including at least one live biometric data sample captured by the at least one verifier entity node and at least one parameter indicating a piece of data from the user cryptograph to be revealed to the at least one verifier entity; generate a stable bio-hash from the at least one live biometric data sample; deriving the at least one parameter from the request; generate a decryption key comprising a plurality of shards from the at least one live biometric data sample; and providing at least one of the plurality of shards to the at least one verifier entity node based on the at least one parameter.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1A illustrates a network diagram of a system for an automated real-time digital identity verification based on live biometrics consistent with the present disclosure;

FIG. 1B illustrates a network diagram of a system for an automated real-time digital identity verification based on live biometrics employing a blockchain consistent with the present disclosure;

FIG. 2 illustrates a network diagram of a system including detailed features of an identity verification (IV) node consistent with the present disclosure;

FIG. 3A illustrates a flowchart of a method for an automated real-time digital identity verification based on live biometrics consistent with the present disclosure;

FIG. 3B illustrates a further flowchart of a method for an automated real-time digital identity verification based on live biometrics consistent with the present disclosure;

FIG. 4 illustrates use of the cryptograph on the user ID consistent with the present disclosure;

FIG. 5 illustrates a block diagram of a system including a computing device for performing the method of FIGS. 3A and 3B.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of such term herein. To the extent that the meaning of a term used herein-as understood by the ordinary artisan based on the contextual use of such term-differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The present disclosure includes many aspects and features. Moreover, while many aspects and features relate to, and are described in, the context of lead-based recommendations, embodiments of the present disclosure are not limited to use only in this context.

The present disclosure provides a system, method and computer-readable medium for an automated real-time digital identity verification based on live biometrics and cryptograph(s) provided on user IDs or separately. In one embodiment, the system overcomes the limitations of existing user identity verification methods by employing live biometrics for generation of decryption keys. By leveraging the capabilities of selective decryption based on biometrics-based keys and key shards, the disclosed approach offers a significant improvement over existing solutions discussed above in the background section.

In one embodiment of the present disclosure, the system provides for verification of the credential and associated identity binding using biometrics in a decentralized fashion in an offline or online manner. The disclosed embodiments eliminate or reduces the above-mentioned shortcomings to successfully verify the credentials as follows:

1. The credential can be quickly provisioned and distributed over the air, online, or in physical form.

2. The credential can be carried in a physical or digital form, i.e., printed on paper or stored as an image in a wallet in a mobile phone or handheld or wearable device.

3. The credential (or ID) can hold all the necessary information required for visual and automated confirmation/verification in a compact form that can be optically or electronically read.

4. Verification can be done using purpose-built devices, mobile phones, PCs, or any computing device with a camera.

5. Identity binding can be achieved via on-the-spot offline biometric verification (without using a pre-stored biometric template) using any or all available modalities like face, finger, iris, palm, and voice or more.

6. The claims or other relevant information is stored in an encrypted form which can be decrypted/unlocked only by a key that is a combination of a common key issues by the issuing authority and keys derived using a Key Derivation Function (KDF) based on data unique to the biometric data of the ID owner.

The proposed system is realized through innovation in several components that are employed for the identity verification process. To address the need of verifying the user offline, the biometric information may be readily accessible in an offline or online mode. To achieve this, a proprietary face image (or another biometric data) compression algorithm may be used. In case of using the face, the algorithm allows the compression of facial portraits to 800 bytes and still retain good quality for visual verification. In one embodiment, for the biometric matching, the compression technology allows for storing the compact biometric feature representation called templates for face, fingerprint templates, voice, palm, iris, and other biometric modalities. In one embodiment, this compact representation of the credential may be stored and can be presented in a high-density barcode that has significantly higher storage capacity. The compact representation may be also stored in a blockchain or in other forms on available storage mediums that can be easily accessed.

The technology employed in the disclosed embodiments may allow for storing other personally identifiable information or other relevant information to be stored in an encrypted form using either symmetric or asymmetric encryption. The encrypted personally identifiable information can be based on any data which is unique to the ID owner. For example:

1. A unique ID of the entity/individual.

2. A unique passcode/password that only the entity/user will be aware of.

3. A hash or a secret key derived from the entity/user's biometric modalities.

The issuing authority's public key (or symmetric key) can also be used in the above encryption scheme as a part of the key derivation process to ensure that only cryptographs issued using the corresponding private (or symmetric) key generated based the user biometrics can be decrypted by a corresponding key also generate based on the live biometrics of the same user.

In one embodiment, the information in the cryptograph can only be unlocked after the biometrics stored in the cryptograph are decrypted and matched to the live biometrics captured by any device with an integrated camera system. The live biometrics capture may include a liveness check to avoid spoof presentation attacks. In another embodiment, the personal identifiable information (PII) may be encrypted using the secret derived from the biometrics of the identity owner, allowing access to the information only when the presenter is in front of the verifier. The data may be double encrypted or digitally signed by issuing authority for which the keys could be stored on blockchain. In addition, the disclosed technology allows for tamper detection using a digital signature applied on the payload.

The overall outcome of the verification system allows the storage and retrieval of one's identity information in compact form that can be carried in multiple forms, including machine-readable code printed on paper (or stored on user's mobile device) that can be biometrically verified using any device with a camera. The benefits of this approach allow the systems to be decentralized, highly scalable while maintaining the security and privacy of the user. The possibility to carry all sensitive information in a machine-readable code or compact representation that stays with the owner of the identity reduces the requirement for a centralized database and thus reducing the attack vectors and avoiding data breaches.

In one embodiment, the disclosed technology may be also used as a foundation block of Self Sovereign Identity (SSI)-based digital identity wallets built based on the standards of World Wide Web Consortium (W3C) and powered by the biometrics. Such digital wallets may promote privacy preservation, enhanced security, and a smooth user experience. Advantageously, there is no central mediator, such as an identity service provider (who keeps all user data, including transactions) as all credentials stay in the wallet and are fully controlled by its holder. The issuing authorities still independently have control over the information they have issued to the wallet, but the user becomes the central holder of those credentials. The benefits of SSI-based digital identity wallets may extend widely, providing secure and interoperable systems that enhance public service efficiency, contribute to digital economy growth, and offer broader access to financial and social services. Furthermore, these wallets have societal impacts by instilling trust in digital transactions and promoting social inclusion.

The disclosed embodiments may be platform agnostic. The disclosed system, advantageously, seamlessly integrates with a multitude development tools, enabling users to manage applications through a singular dashboard interface.

In one embodiment, the user and verifier entities may be connected to the digital identification verification (IV) node (or may be implemented on the IV node) over a blockchain network to achieve a consensus prior to executing a transaction to release the user identification decision data based on the identity verification recommendations or biometrics-based decryption keys (or key shards).

One of the disclosed embodiments provide for a biometric-based security feature that can be printed on an identity document alongside the user name—as a “digital security feature.” This feature is a high-density machine-readable two-dimensional code containing a facial biometric template and/or a facial biometric hash generated from the original facial image. Verification consists of capturing the two together. An application can then compare the template and/or hash in the code with another template and/or hash generated on-the-fly from the printed facial image or from live face capture of the document presenter, all in real time. The solution also involves reading the biographic data printed on the identity document and them comparing it with the biographic data stored in the code. In one embodiment, a shortened (i.e., compressed) biometric hash may be used and the verification process may implement AI processing of the compressed biometric hash. This way less biometric data is sufficient for identity verification.

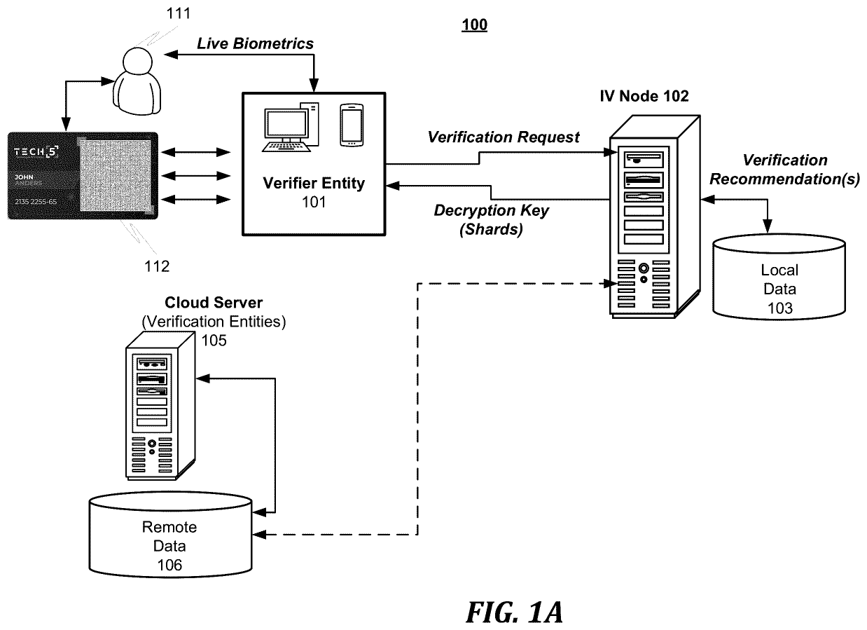

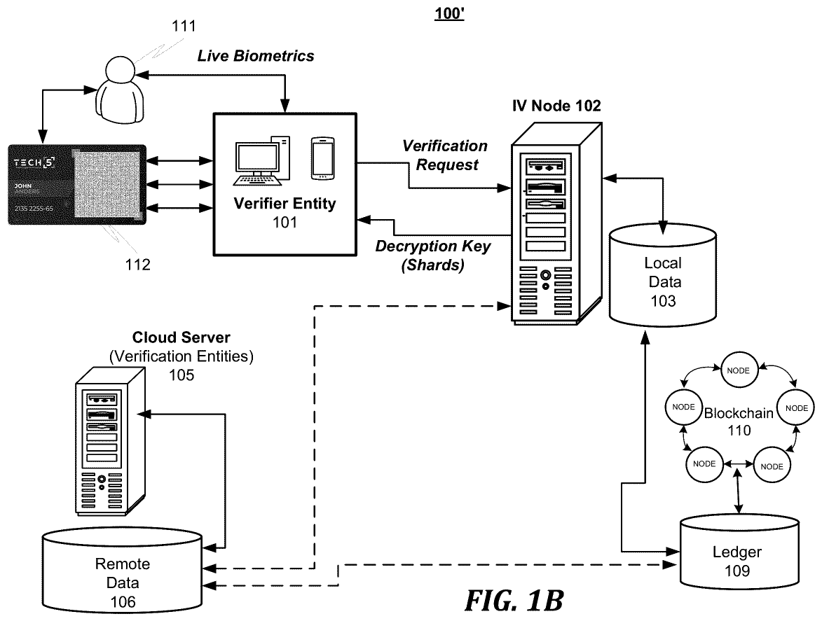

The disclosed concept is proposed for verifying a credential and associated identity binding using biometrics. In one embodiment, the system generates a machine-readable two-dimensional code containing a facial biometric template and/or facial biometric hash, and biographical data extracted from the original application data. Once such a code is generated, it can be printed on an identity document such as ID card, driver's license, passport, etc. containing a printed facial image and biographic data. Once again, this data may be used in a compressed form so less computations are needed. Thereafter, an electronic device with an integrated camera subsystem (including smartphones) can be used to simultaneously read the code, read the printed facial image, and read the printed biographic data using Optical Character Recognition (OCR). FIG. 1A illustrates a network diagram of a system for an automated real-time digital identity verification based on user live biometrics data consistent with the present disclosure.

Referring to FIG. 1A, the example network 100 includes the identification verification (IV) node 102 connected to a cloud server node(s) 105 over a network. The IV node 102 may receive an identity verification request containing a live biometrics of carrier user 111 from a verifier entity 101. The request may include one or several identifiers of biographic data pieces requested to be unlocked (i.e., decrypted). As discussed above, a digital security feature in a form of a cryptograph 112 may be encoded and embedded on the identity document alongside the name of the carrier user 111. In one embodiment, the ID card may only contain the cryptograph 112 represented by digital security features including encrypted biographic data such as name, birthdate, gender, SSN (or document number), etc. The high density machine-readable two-dimensional cryptograph 112 code may be printed on or otherwise embedded into the user 111 identity document during credential generation. The machine-readable code is a highly secure data container which is presented as a dense two-dimensional machine-readable code. The biographic data contained in the cryptograph 112 may be encrypted with a key generated based on the Bio-Hash produced from the carrier's biometric sample data. The encryption key may consist of n-shards designated to the encryption of particular pieces of the biographic data. For example, 1-shard encrypts the carrier's name, 2-shard encrypts carrier's date of birth, 3-shard encrypts personal document number, etc. The full encryption key constructed of all shards may encrypt the entire biographic data.

As discussed above, the live biometric data may be provided to the IV node 102 configured to generate a stable Bio-Hash that is used for generation of the decryption key (or decryption n-shards). Based on the verification request, a particular n-shard may be provided to the verifier entity 101 for description of a corresponding piece of the biographic data. If the request specifies decryption of the entire cryptograph 112, the full decryption key including all of the n-shards is provided to the verifier entity 101.

In one embodiment, a biometric hash produced from carrier's biometric sample of a different kinds may be encrypted within the cryptograph 112. The cryptograph 112 may contain encrypted biometric sample of a different type than the one used for generation of the encryption/decryption keys. For example, the decryption key may be generated based on the facial image biometrics of the user 101 while the cryptograph 112 contains the fingerprint-based biometric sample. The decrypted fingerprint-based biometric sample may be used for a second round of validation against the prestored biometric templates retrieved from a local data storage 103 or alternatively from a remote data storage 106.

In one embodiment, the validated fingerprint-based biometric sample may be hashed to produce a decryption key (or a set of n-shards) to be used to unlock (decrypt) the selected data (or the entire data form the cryptograph).

The cryptograph 112 code may also have an expiry date which can inform the verifier entity 101 that the identity document has been expired and needs re-issuance. In one embodiment, an authorized verifier entity 101 can access the data stored in the cryptograph 112, using authorized applications installed on electronic devices with integrated camera subsystems—smartphones, computer, etc. A proprietary application called the Digital ID app may be configured for reading digital IDs containing cryptograph, both visually and digitally stored in the device's storage. The Digital ID app works for both iOS and Android.

Although the application uses proprietary technologies to capture biometric data, the integrator can change the underlying technology based on their requirements.

In one embodiment, a selective data disclosure is implemented as discussed above. The cryptograph 112 may be customized to encrypt different parts of the cryptograph using different keys referred to as the key shards. This facilitates the selective disclosure, wherein the user has the option to only show the most relevant data from the cryptograph 112 to the verifier entity 101. The key consisting of n-key shards may be implemented as a PIN code, an alphanumeric password, a passphrase, or a stable biometric hash. Regardless of the implementation, the encryption/decryption keys are generated based on user 111 biometrics (previously acquired and acquired live). For example, if a verifying party is a bouncer at a club who should only know the age of the user and no other information, the user can then permit the verifying party to only access the age information stored in the cryptograph 112.

In one embodiment, the key (or the n-key shards) may me generated from a stable biometric hash. Unlike the conventional biometrics matching-based user verification, based on the cryptograph 112 design, the very first level of encryption is a form of symmetric encryption and needs a specific string of characters (i.e., an encryption key) to encrypt and decrypt the data (only in the 1^{st} layer). Here, a PIN code, passphrase, or an alphanumeric password can be used. However, every time the user wants a verifying party to read the cryptograph 112, he/she has to share some sort of passcode which helps in deriving the encryption key.

A major disadvantage of this method is that the user is required to remember the passcode. Thus, the proposed idea of the current application is to use the biometric data of the user since it is always available and would not change over time, adding a layer of convenience.

However, it is known that the biometric features from the same identity are similar, but may not be exactly the same. Thus, these biometric-based passwords discussed above have to be stable, meaning that the key (i.e., or a hash representing a string of alphanumeric characters) derived from the biometric data is the same for the user identity. To that end, a proprietary algorithm referred to as Bio-Hash may be used to extract stable biometric hashes from the biometric samples.

In one embodiment, the algorithm may use a convolutional neural network followed by a custom fully connected layer such that for every input biometric sample image, the extracted feature only has −1 or +1 values. This is achieved by using the Tanh activation function so that the system may output a binary feature for every biometric input. Any standard hash can then be applied on this binary feature to output a 128-bit, 256-bit, 512-bit, or 1024-bit hash. While the biometric features are similar to each other but are not necessarily the same, adding an innovative fully connected layer at the end of a typical feature extractor, the algorithm essentially forces the “similar” features to be exactly the same, thereby creating a stable Bio-Hash that can be used for generation of a key or multiple key shards.

In one embodiment, the entire system depicted in FIG. 1 can be used offline in a smartphone. Specifically, the IV node 102 and biometrics capture/verification can be implemented locally on the smartphone and be available for offline use. The credential with the Cryptograph 112 can be both physical and digital (i.e., digital identity document).

Referring to FIG. 1B, the example network 100′ includes the identification verification (IV) node 102 connected to a cloud server node(s) 105 over a network. As discussed above, the IV node 102 may receive an identity verification request containing a live biometrics of carrier user 111 from a verifier entity 101. The request may include one or several identifiers of biographic data pieces requested to be unlocked (i.e., decrypted). As discussed above, a digital security feature in a form of a cryptograph 112 may be encoded and embedded on the identity document alongside the name of the carrier user 111. In one embodiment, the ID card may only contain the cryptograph 112 represented by digital security features including encrypted biographic data such as name, birthdate, gender, SSN (or document number), etc. The high density machine-readable two-dimensional cryptograph 112 code may be printed on or otherwise embedded into the user 111 identity document during credential generation. The machine-readable code is a highly secure data container which is presented as a dense two-dimensional machine-readable code. The biographic data contained in the cryptograph 112 may be encrypted with a key generated based on the Bio-Hash produced from the carrier's biometric sample data. The encryption key may consist of n-shards designated to the encryption of particular pieces of the biographic data. For example, 1-shard encrypts the carrier's name, 2-shard encrypts carrier's date of birth, 3-shard encrypts personal document number, etc. The full encryption key constructed of all shards may encrypt the entire biographic data.

As discussed above, the live biometric data may be provided to the IV node 102 configured to generate a stable Bio-Hash that is used for generation of the decryption key (or decryption n-shards). Based on the verification request, a particular n-shard may be provided to the verifier entity 101 for description of a corresponding piece of the biographic data. If the request specifies decryption of the entire cryptograph 112, the full decryption key including all of the n-shards is provided to the verifier entity 101.

In one embodiment, a biometric hash produced from carrier's biometric sample of a different kinds may be encrypted within the cryptograph 112. The cryptograph 112 may contain encrypted biometric sample of a different type than the one used for generation of the encryption/decryption keys. For example, the decryption key may be generated based on the facial image biometrics of the user 101 while the cryptograph 112 contains the fingerprint-based biometric sample. The decrypted fingerprint-based biometric sample may be used for a second round of validation against the pre-stored biometric templates retrieved from a local data storage 103 or alternatively from a remote data storage 106.

The pre-stored biometric templates may be retrieved from a the blockchain 110 ledger 109. In one embodiment, the n-key shard may be recorded on the ledger 109 for future use. In one embodiment, a blockchain 110 consensus among multiple verifier entities 101 may be reached prior to release and recordation of the n-key shards.

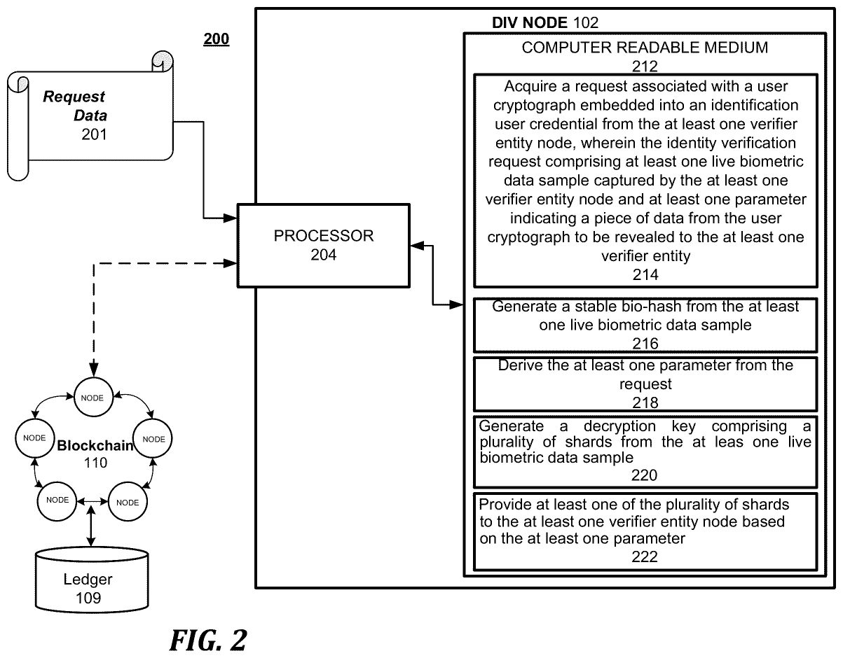

FIG. 2 illustrates a network diagram of a system including detailed features of a digital identification verification (IV) node consistent with the present disclosure.

Referring to FIG. 2, the example network 200 includes the IV node 102 connected to the verifier entity 101 (see FIGS. 1A-B) to receive user request data 201. As discussed above with respect to FIGS. 1A-B, the IV node 102 may receive the request containing live biometric capture data of a carrier provided by the verifier entity 101 (FIG. 1A-B). As discussed above, the pre-stored biometric hash data may be retrieved from the ledger 109 of the blockchain 110.

In one embodiment, the request may contain data indicating what pieces of data for the cryptograph are requested to be revealed (i.e., decrypted). In this case, the IV node 102 may provide only the decryption n-shards corresponding to the requested pieces of data.

While this example describes in detail only one IV node 102, multiple such nodes may be connected to the network and to the blockchain 110. It should be understood that the IV node 102 may include additional components and that some of the components described herein may be removed and/or modified without departing from a scope of the IV node 102 disclosed herein. The IV node 102 may be a computing device or a server computer, or the like, and may include a processor 204, which may be a semiconductor-based microprocessor, a central processing unit (CPU), an application specific integrated circuit (ASIC), a field-programmable gate array (FPGA), and/or another hardware device. Although a single processor 204 is depicted, it should be understood that the IV node 102 may include multiple processors, multiple cores, or the like, without departing from the scope of the IV node 102 system.

The IV node 102 may also include a non-transitory computer readable medium 212 that may have stored thereon machine-readable instructions executable by the processor 204. Examples of the machine-readable instructions are shown as 214-222 and are further discussed below. Examples of the non-transitory computer readable medium 212 may include an electronic, magnetic, optical, or other physical storage device that contains or stores executable instructions. For example, the non-transitory computer readable medium 212 may be a Random-Access memory (RAM), an Electrically Erasable Programmable Read-Only Memory (EEPROM), a hard disk, an optical disc, or other type of storage device.

The processor 204 may fetch, decode, and execute the machine-readable instructions 214 to acquire a request associated with a user cryptograph embedded into an identification user credential from the at least one verifier entity node, wherein the identity verification request comprising at least one live biometric data sample captured by the at least one verifier entity node and at least one parameter indicating a piece of data from the user cryptograph to be revealed to the at least one verifier entity. The processor 204 may fetch, decode, and execute the machine-readable instructions 216 to generate a stable bio-hash from the at least one live biometric data sample. The processor 204 may fetch, decode, and execute the machine-readable instructions 218 to derive the at least one parameter from the request. The processor 204 may fetch, decode, and execute the machine-readable instructions 220 to generate a decryption key comprising a plurality of shards from the at least one live biometric data sample. The processor 204 may fetch, decode, and execute the machine-readable instructions 222 to provide at least one of the plurality of shards to the at least one verifier entity node based on the at least one parameter.

The permissioned blockchain 110 may be configured to use one or more smart contracts that manage transactions for multiple participating nodes and for recording the transactions on the ledger 109. Note that the IV node 102 system may prioritize using its own biometric samples data 103 from local databases. This ensures a faster, more tailored response to the identity verification requests. Local datasets may be recorded on a private (permissioned) blockchain 110. This provides a tamper-evident log of user identity verifications, enhancing security and transparency.

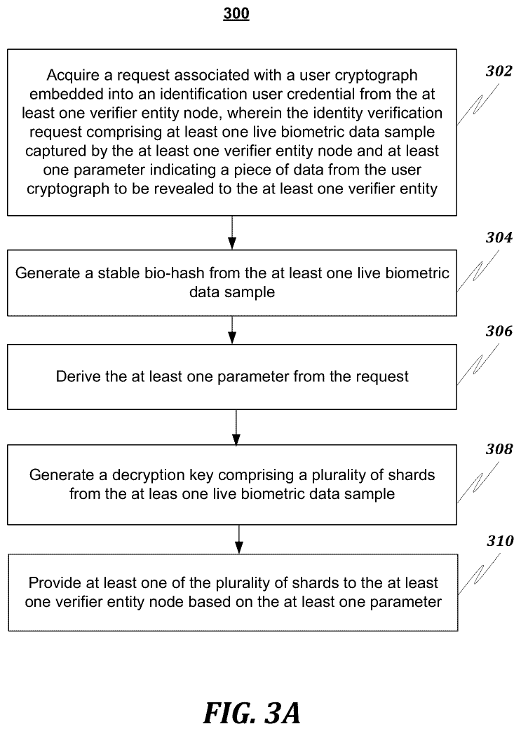

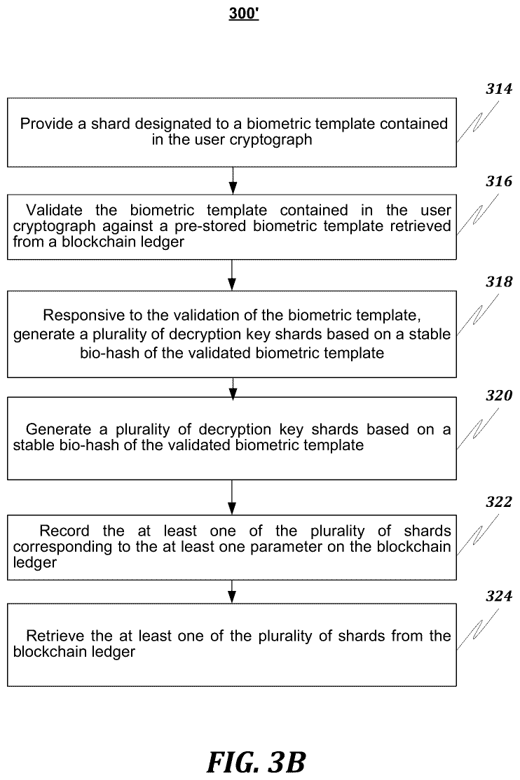

FIG. 3A illustrates a flowchart of a method for an automated real-time digital identity verification based on live biometrics data of a user consistent with the present disclosure.

Referring to FIG. 3A, the method 300 may include one or more of the steps described below. FIG. 3A illustrates a flow chart of an example method executed by the IV node 102 (see FIG. 2). It should be understood that method 300 depicted in FIG. 3A may include additional operations and that some of the operations described therein may be removed and/or modified without departing from the scope of the method 300. The description of the method 300 is also made with reference to the features depicted in FIG. 2 for purposes of illustration. Particularly, the processor 204 of the IV node 102 may execute some or all of the operations included in the method 300.

With reference to FIG. 3A, at block 302, the processor 204 may acquire a request associated with a user cryptograph embedded into an identification user credential from the at least one verifier entity node, wherein the identity verification request comprising at least one live biometric data sample captured by the at least one verifier entity node and at least one parameter indicating a piece of data from the user cryptograph to be revealed to the at least one verifier entity. At block 304, the processor 204 may generate a stable bio-hash from the at least one live biometric data sample. At block 306, the processor 204 may derive the at least one parameter from the request. At block 308, the processor 204 may generate a decryption key comprising a plurality of shards from the at least one live biometric data sample. At block 310, the processor 204 may provide at least one of the plurality of shards to the at least one verifier entity node based on the at least one parameter.

FIG. 3B illustrates a further flowchart of a method for an automated real-time digital identity verification based on live biometrics of a user consistent with the present disclosure.

Referring to FIG. 3B, the method 300′ may include one or more of the steps described below. FIG. 3B illustrates a flow chart of an example method executed by the IV node 102 (see FIG. 2). It should be understood that method 300′ depicted in FIG. 3B may include additional operations and that some of the operations described therein may be removed and/or modified without departing from the scope of the method 300′. The description of the method 300′ is also made with reference to the features depicted in FIG. 2 for purposes of illustration. Particularly, the processor 204 of the IV node 102 may execute some or all of the operations included in the method 300′.

With reference to FIG. 3B, at block 314, the processor 204 may provide the plurality of shards to decrypt the user cryptograph in its entirety. Note that each of the plurality of shards corresponds to a designated biographic data piece encrypted within the user cryptograph.

At block 316, the processor 204 may provide a shard designated to a biometric template contained in the user cryptograph. At block 318, the processor 204 may validate the biometric template contained in the user cryptograph against a pre-stored biometric template retrieved from a blockchain ledger.

At block 320, the processor 204 may, responsive to the validation of the biometric template, generate a plurality of decryption key shards based on a stable bio-hash of the validated biometric template. Note that the biometric template represents biometrics of a different type from the at least one live biometric data sample. At block 322, the processor 204 may record the at least one of the plurality of shards corresponding to the at least one parameter on the blockchain ledger. At block 324, the processor 204 may retrieve the at least one of the plurality of shards from the blockchain ledger.

As discussed above, the IV node 102 may use a decentralized storage such as a blockchain 110 (see FIG. 1B) that is a distributed storage system, which includes multiple nodes that communicate with each other. The decentralized storage includes an append-only immutable data structure resembling a distributed ledger capable of maintaining records between mutually untrusted parties. The untrusted parties are referred to herein as peers or peer nodes. Each peer maintains a copy of the parameter(s) records and no single peer can modify the records without a consensus being reached among the distributed peers. For example, the peers in FIG. 1B may execute a consensus protocol to validate blockchain 110 storage transactions, group the storage transactions into blocks, and build a hash chain over the blocks. This process forms the ledger 109 by ordering the storage transactions, as is necessary, for consistency. In various embodiments, a permissioned and/or a permissionless blockchain can be used. In a public or permissionless blockchain, anyone can participate without a specific identity. Public blockchains can involve assets and use consensus based on various protocols such as Proof of Work (PoW). On the other hand, a permissioned blockchain provides secure interactions among a group of entities which share a common goal such as storing lead response parameters for efficient handling of leads, but which do not fully trust one another.

This application utilizes a permissioned (private) blockchain that operates arbitrary, programmable logic, tailored to a decentralized storage scheme and referred to as “smart contracts” or “chaincodes.” In some cases, specialized chaincodes may exist for management functions and parameters which are referred to as system chaincodes. The application can further utilize smart contracts that are trusted distributed applications which leverage tamper-proof properties of the blockchain database and an underlying agreement between nodes, which is referred to as an endorsement or endorsement policy. Blockchain transactions associated with this application can be “endorsed” before being committed to the blockchain while transactions, which are not endorsed, are disregarded. An endorsement policy allows chaincodes to specify endorsers for a transaction in the form of a set of peer nodes that are necessary for endorsement. When a client sends the transaction to the peers specified in the endorsement policy, the transaction is executed to validate the transaction. After a validation, the transactions enter an ordering phase in which a consensus protocol is used to produce an ordered sequence of endorsed transactions grouped into blocks.

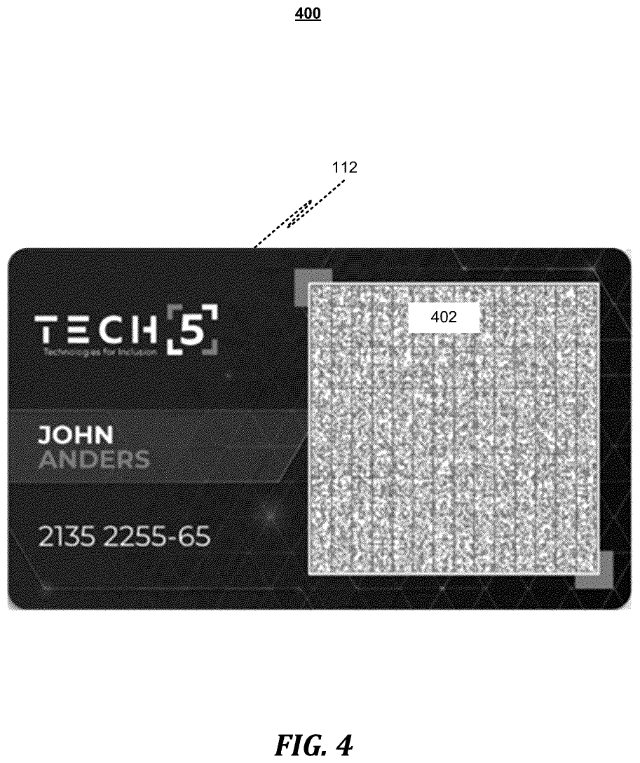

FIG. 4 illustrates use of the cryptograph on the user ID consistent with the present disclosure.

The example depicted in FIG. 4 shows the digital ID 112 with all crucial components. At the heart of the disclosed solution is a cryptograph 402, which is essentially a secure and decentralized data container.

The identity document may be generated as follows. Typical identity documents such as driver's license, passport, etc. all have a printed facial image along with printed biographic data such as name, birthdate, gender, etc. At the heart of the disclosed embodiments is the high density machine-readable two-dimensional cryptograph 112 which can be printed on the identity document either during credential generation or even at a later stage using reliable pasting mechanisms. The cryptograph 112 is a highly secure data container which is presented as a dense two-dimensional machine-readable code. The cryptograph 112 is better than other known 2-D codes allowing a safe storage space for biometrics and other personal identifiable information (PII). The proposed code is advantages over other known codes listed below:
While a standard 2-D code can only store up to 3 KB of data, this code can store up to 703 KB of data.
Industry-grade encryption requires a minimum of 2048-bit encryption which other codes cannot accommodate due to their storage constraints. However, the code can support all standard encryption schemes due to its higher capacity.
Other codes include specific patterns in their visual representation which are required for decoding. However, the proposed code does not have any such dependency and can thus start the decoding process immediately.
While other codes have a pre-determined shape of either a square or a rectangle, the code can adapt to any rectangle shape as per requirements.
The code also has a higher tolerance when it comes to error correction. Based on the error correction level, the code is tolerant to noise, occlusion, marks, deformities, and other irregularities.
Most importantly, only an authorized person/authority can decode and read the contents of the code. This is ensured by a three-layer security.

According to the disclosed embodiments, the code provides a number of improvements and changes:

1. Versioning to track various versions of the code for efficient decoding.

2. Innovative 5-bytes expiry date which extends the maximum validity to the year 2500. It can also be changed as per requirements.

3. Storing the DPI (dots per inch) information in a manner that facilitates printers to automatically use it for printing.

4. Selective disclosure-different parts of the code can be unlocked by different keys (n-key shards) derived from passwords, private/public keys, stable Bio-hashes from live-generated or stored biometric templates, etc.

Generating the machine-readable code involves following inputs:

### Compressed Facial Image

A proprietary face compression algorithm may be implemented. The algorithm can compress any input face image to a compressed format which is only 800 bytes in size. The algorithm is based on image-processing techniques and takes into account facial landmarks (eyes, nose, mouth, etc. positions) to ensure that it retains the most amount of information regarding areas that matter the most when it comes to visual verification.

The algorithm consists of an “encoder” and “decoder.” The encoder takes in a facial input image and outputs a compressed representation of the face in a binary format. The decoder takes this compressed representation and outputs a compressed facial image which can effectively be used for visual verification.

The input image to the algorithm can be any digital format of a human face in any standard lossy or lossless format—PNG, BMP, JPEG, TIFF, etc.

The algorithm then detects facial landmarks that identify different regions of the face such as cheeks, chin, eyes, lips, ears, nose, etc.

The algorithm then takes into account the fact that for visual face verification, some regions are favored more than others. In particular, regions such as the mouth, eyes, nose, and eyebrow are given more importance than other regions such as the cheeks, forehead, etc. What “importance” means here is how much to compress those regions. With high-importance regions, the encoder compresses the image in a way such that the decoded facial image shows more information pertaining to those areas. Similarly, with low-importance regions, the encoder compresses those areas in a way that less information is stored in the compressed representation.

Since the algorithm deals with pixel values of face images, the final compressed representation will be variable in size. However, the algorithm ensures that the size is always below 800 bytes by pre-allocating sizes for different facial areas to be compressed. The compressed representation can either be a variable sized binary file, or a fixed-size 800 bytes binary blob by appropriately padding the binary data. Also, the encoder features multiple compression levels based on the requirements. The minimum compressed representation is 800 bytes but it can be increased to any higher value. For instance, if the compressed representation is to be 1200 bytes, the encoder creates the compressed representation just less than 1200 bytes and the remaining bytes are padded. The decoder takes as input this binary compressed representation and outputs a compressed facial image. This output image can then be used to visually verify either a live person, their physical image (ex: from an ID card), or a digital image stored in any database.

### Biographic Data

The cryptograph in the digital ID can also store relevant biographic details regarding its user/carrier. This can include name, birthday, email, phone, driver's license number, address, etc.

### Biometric Templates

To make the proposed digital ID biometrically linked to the user, we store the user's biometric information as biometric templates. These templates can be derived from face, fingerprints, iris, voice, palm, etc. There can be one or multiple biometric templates.

The biometric templates can be extracted from any typical biometric recognition system, both model-based and learning-based approaches. The biometric templates store the identity information of the user in a secure format. The disclosed machine learning based recognition systems may extract templates in a way which makes it infeasible to revert them back to the input samples and to get any other information such as race, gender, etc. The disclosed recognition systems have very light-weight templates for efficient storage. The face templates are a meagre 136 bytes while fingerprint templates are 186 bytes.

### Biometric Hash

In current biometric recognition systems, a biometric sample is taken as an input and converted to a “feature” or a “template.” This feature is a numerical representation of the identity of the biometric sample. The features are extracted to minimize intra-class variations (meaning that the features should not vary much if they are from the same identity) and maximize inter-class variations (meaning that the features of two identities should be as apart as possible).

When two features are matched to know if they are from the same identity or not, they are subjected to a mathematical function which extracts a similarity score between the features. The similarity score is then compared with a statistically pre-determined threshold to decide if the features are of the same identity or not. This is called as probabilistic matching since the threshold correlates with the probability of the identities being the same. Now, based on the disclose Cryptograph design, the very first level of encryption is a form of symmetric encryption and needs a specific string of characters (encryption key) to encrypt and decrypt the data (only in the 1^{st} layer). Here, a pin code, passphrase, or an alphanumeric password can be used. However, every time the user wants a verifying party to read the Cryptograph, he/she has to share some sort of passcode which helps in deriving the encryption key.

A major disadvantage of this method is that the user is required to remember the passcode. Thus, the idea here is to use the biometric data of the user since it is always available and would not change over time, adding a layer of convenience. However, it is known that the biometric features from the same identity are similar, but not the same. Thus, the “biometric” password discussed above have to be stable, meaning that the key or hash (a string of alphanumeric characters) derived from the biometric data is the same for an identity. To that end an algorithm referred to as BioHash is provided to extract stable biometric hashes from biometric samples.

The algorithm may employ a convolutional neural network followed by a custom fully connected layer such that for every input biometric sample image, the extracted feature only has −1 or +1 values. This is achieved by using the Tanh activation function and we thus output a binary feature for every biometric input. Any standard hash can then be applied on this binary feature to output a 128-bit, 256-bit, 512-bit, or 1024-bit hash. It is known that biometric features are similar to each other, but not the same. However, with adding an innovative fully connected layer at the end of a typical feature extractor, the system can force the “similar” features to be exactly the same.

### Multiple Users

Although the digital ID is generally restricted to only one user, there can be use-cases where multiple people can use the same digital ID. For instance, a refugee family can have a single digital ID where the entire family's biographic and biometric data is stored in a single cryptograph.

Once the identity document is generated, its authenticity can be verified using the information stored in the machine-readable code. This includes reading the contents of the document and then multi-layer verification using a verifier application on devices with integrated camera subsystems (typically smartphones).

A live biometric template (face, voice, iris, finger print, etc.) and/or facial biometric hash can be extracted from a live capture of the user employing a standard face (or other) biometric capture technology. The biometric data may be used for generation of the decryption key consisting of n-shards. Each of the shards may be used to decrypt a selected portion of the cryptograph 112 that was encrypted by the corresponding encryption key consisting of n-shards generated based on the prestored or previously captured biometric data of the same user.

In one embodiment, the cryptograph 112 may contain encrypted biometric sample of a different type than the one used for generation of the decryption key. For example, the decryption key may be generated based on the facial image biometrics of the user while the cryptograph 112 contains the fingerprint-based biometric sample. The decrypted fingerprint-based biometric sample may be used as a second round of validation against the prestored biometric templates. In one embodiment, the validated fingerprint-based biometric sample may be hashed to produce a decryption key (or a set of n-shards) to be used to inlock the selected data (or the entire data form the cryptograph).

The biometric template/hash can be compared to the template/hash extracted from the storage such as blockchain. This comparison can be carried out using a mathematical function to output a similarity score. A typical range of this score is [0, 1] where 0 means that the two features/hashes are completely different whereas 1 means that the two features/hashes are the same. However, in case of the compressed hash that has some missing data, the determination may be made by the AI that ingests some extracted features form the hash and compares them to either full set of features extracted from the stored biometric sample or from a live biometric capture. For the biometric sample/templates, the similarity score may be compared with a statistically pre-determined threshold to decide if it is a successful match or not. For facial biometric hash, the similarity score has to be a perfect score since every bit of the two hashes should be the same.

As discussed above, in one embodiment, the features and/or the actions described and/or depicted herein can occur on or with respect to the blockchain 110. The above embodiments of the present disclosure may be implemented in hardware, in computer-readable instructions executed by a processor, in firmware, or in a combination of the above. The computer computer-readable instructions may be embodied on a computer-readable medium, such as a storage medium. For example, the computer computer-readable instructions may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

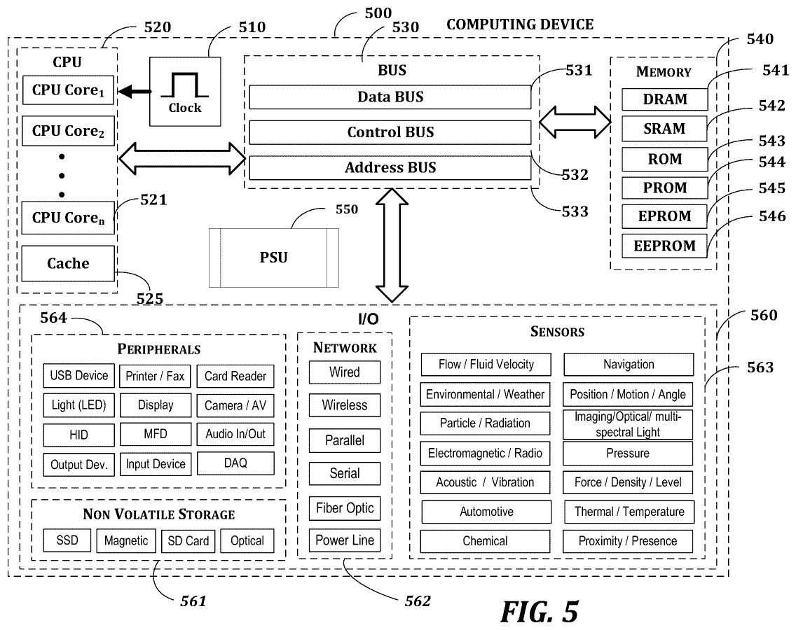

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative embodiment, the processor and the storage medium may reside as discrete components. For example, FIG. 5 illustrates an example computing device (e.g., a server node) 500, which may represent or be integrated in any of the above-described components, etc.

FIG. 5 illustrates a block diagram of a system including computing device 500. The computing device 500 may comprise, but not be limited to the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exa-scale supercomputer, a mainframe, or a quantum computer;
A minicomputer, wherein the minicomputer computing device comprises, but is not limited to, an IBM AS500/iSeries/System I, A DEC VAX/PDP, a HP3000, a Honeywell-Bull DPS, a Texas Instruments TI-990, or a Wang Laboratories VS Series;
A microcomputer, wherein the microcomputer computing device comprises, but is not limited to, a server, wherein a server may be rack mounted, a workstation, an industrial device, a raspberry pi, a desktop, or an embedded device;
The IV node 102 (see FIG. 2) may be hosted on a centralized server or on a cloud computing service. Although method 300 has been described to be performed by the IV node 102 implemented on a computing device 500, it should be understood that, in some embodiments, different operations may be performed by a plurality of the computing devices 500 in operative communication at least one network.

Embodiments of the present disclosure may comprise a computing device having a central processing unit (CPU) 520, a bus 530, a memory unit 540, a power supply unit (PSU) 550, and one or more Input/Output (I/O) units. The CPU 520 coupled to the memory unit 540 and the plurality of I/O units 560 via the bus 530, all of which are powered by the PSU 550. It should be understood that, in some embodiments, each disclosed unit may actually be a plurality of such units for the purposes of redundancy, high availability, and/or performance. The combination of the presently disclosed units is configured to perform the stages of any method disclosed herein.

Consistent with an embodiment of the disclosure, the aforementioned CPU 520, the bus 530, the memory unit 540, a PSU 550, and the plurality of I/O units 560 may be implemented in a computing device, such as computing device 500. Any suitable combination of hardware, software, or firmware may be used to implement the aforementioned units. For example, the CPU 520, the bus 530, and the memory unit 540 may be implemented with computing device 500 or any of other computing devices 500, in combination with computing device 500. The aforementioned system, device, and components are examples and other systems, devices, and components may comprise the aforementioned CPU 520, the bus 530, the memory unit 540, consistent with embodiments of the disclosure.

At least one computing device 500 may be embodied as any of the computing elements illustrated in all of the attached figures, including the IV node 102 (FIG. 2). A computing device 500 does not need to be electronic, nor even have a CPU 520, nor bus 530, nor memory unit 540. The definition of the computing device 500 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 500, especially if the processing is purposeful.

With reference to FIG. 5, a system consistent with an embodiment of the disclosure may include a computing device, such as computing device 500. In a basic configuration, computing device 500 may include at least one clock module 510, at least one CPU 520, at least one bus 530, and at least one memory unit 540, at least one PSU 550, and at least one I/O 560 module, wherein I/O module may be comprised of, but not limited to a non-volatile storage sub-module 561, a communication sub-module 562, a sensors sub-module 563, and a peripherals sub-module 565.

A system consistent with an embodiment of the disclosure the computing device 500 may include the clock module 510 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 520, the central component of modern computers, which relies on a clock. The only exceptions are asynchronous circuits such as asynchronous CPUs. The clock 510 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 5 wires.

Many computing devices 500 use a “clock multiplier” which multiplies a lower frequency external clock to the appropriate clock rate of the CPU 520. This allows the CPU 520 to operate at a much higher frequency than the rest of the computer, which affords performance gains in situations where the CPU 520 does not need to wait on an external factor (like memory 540 or input/output 560). Some embodiments of the clock 510 may include dynamic frequency change, where the time between clock edges can vary widely from one edge to the next and back again.

A system consistent with an embodiment of the disclosure the computing device 500 may include the CPU unit 520 comprising at least one CPU Core 521. A plurality of CPU cores 521 may comprise identical CPU cores 521, such as, but not limited to, homogeneous multi-core systems. It is also possible for the plurality of CPU cores 521 to comprise different CPU cores 521, such as, but not limited to, heterogeneous multi-core systems, big.LITTLE systems and some AMD accelerated processing units (APU). The CPU unit 520 reads and executes program instructions which may be used across many application domains, for example, but not limited to, general purpose computing, embedded computing, network computing, digital signal processing (DSP), and graphics processing (GPU). The CPU unit 520 may run multiple instructions on separate CPU cores 521 at the same time. The CPU unit 520 may be integrated into at least one of a single integrated circuit die and multiple dies in a single chip package. The single integrated circuit die and multiple dies in a single chip package may contain a plurality of other aspects of the computing device 500, for example, but not limited to, the clock 510, the CPU 520, the bus 530, the memory 540, and I/O 560.

The CPU unit 520 may contain cache 522 such as, but not limited to, a level 1 cache, level 2 cache, level 3 cache or combination thereof. The aforementioned cache 522 may or may not be shared amongst a plurality of CPU cores 521. The cache 522 sharing comprises at least one of message passing and inter-core communication methods may be used for the at least one CPU Core 521 to communicate with the cache 522. The inter-core communication methods may comprise, but not limited to, bus, ring, two-dimensional mesh, and crossbar. The aforementioned CPU unit 520 may employ symmetric multiprocessing (SMP) design.

The plurality of the aforementioned CPU cores 521 may comprise soft microprocessor cores on a single field programmable gate array (FPGA), such as semiconductor intellectual property cores (IP Core). The plurality of CPU cores 521 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 521, for example, but not limited to Instruction-level parallelism (ILP) such as, but not limited to, superscalar pipelining, and Thread-level parallelism (TLP).

Consistent with the embodiments of the present disclosure, the aforementioned computing device 500 may employ a communication system that transfers data between components inside the aforementioned computing device 500, and/or the plurality of computing devices 500. The aforementioned communication system will be known to a person having ordinary skill in the art as a bus 530. The bus 530 may embody internal and/or external plurality of hardware and software components, for example, but not limited to a wire, optical fiber, communication protocols, and any physical arrangement that provides the same logical function as a parallel electrical bus. The bus 530 may comprise at least one of, but not limited to a parallel bus, wherein the parallel bus carry data words in parallel on multiple wires, and a serial bus, wherein the serial bus carry data in bit-serial form. The bus 530 may embody a plurality of topologies, for example, but not limited to, a multidrop/electrical parallel topology, a daisy chain topology, and a connected by switched hubs, such as USB bus. The bus 530 may comprise a plurality of embodiments, for example, but not limited to:
Internal data bus (data bus) 531/Memory bus
Control bus 532
Address bus 533
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as, but not limited to, Accelerated Graphics Port (AGP), Peripheral Component Interconnect extended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/105 bus (e.g., PC/105-Plus, PCI/105-Express, PCI/105, and PCI-105), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1395 Interface/Firewire, Thunderbolt, and extensible Host Controller Interface (xHCI).

Consistent with the embodiments of the present disclosure, the aforementioned computing device 500 may employ hardware integrated circuits that store information for immediate use in the computing device 500, known to the person having ordinary skill in the art as primary storage or memory 540. The memory 540 operates at high speed, distinguishing it from the non-volatile storage sub-module 561, which may be referred to as secondary or tertiary storage, which provides slow-to-access information but offers higher capacities at lower cost. The contents contained in memory 540, may be transferred to secondary storage via techniques such as, but not limited to, virtual memory and swap. The memory 540 may be associated with addressable semiconductor memory, such as integrated circuits consisting of silicon-based transistors, used for example as primary storage but also other purposes in the computing device 500. The memory 540 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 541, Static Random-Access Memory (SRAM) 542, CPU Cache memory 545, Advanced Random-Access Memory (A-RAM), and other types of primary storage such as Random-Access Memory (RAM).
Non-volatile memory which can retain stored information even after power is removed, for example, but not limited to, Read-Only Memory (ROM) 543, Programmable ROM (PROM) 545, Erasable PROM (EPROM) 545, Electrically Erasable PROM (EEPROM) 546 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).
Consistent with the embodiments of the present disclosure, the aforementioned computing device 500 may employ the communication system between an information processing system, such as the computing device 500, and the outside world, for example, but not limited to, human, environment, and another computing device 500. The aforementioned communication system will be known to a person having ordinary skill in the art as I/O 560. The I/O module 560 regulates a plurality of inputs and outputs with regard to the computing device 500, wherein the inputs are a plurality of signals and data received by the computing device 500, and the outputs are the plurality of signals and data sent from the computing device 500. The I/O module 560 interfaces a plurality of hardware, such as, but not limited to, non-volatile storage 561, communication devices 562, sensors 563, and peripherals 565. The plurality of hardware is used by at least one of, but not limited to, human, environment, and another computing device 500 to communicate with the present computing device 500. The I/O module 560 may comprise a plurality of forms, for example, but not limited to channel I/O, port mapped I/O, asynchronous I/O, and Direct Memory Access (DMA).
Consistent with the embodiments of the present disclosure, the aforementioned computing device 500 may employ the non-volatile storage sub-module 561, which may be referred to by a person having ordinary skill in the art as one of secondary storage, external memory, tertiary storage, off-line storage, and auxiliary storage. The non-volatile storage sub-module 561 may not be accessed directly by the CPU 520 without using an intermediate area in the memory 540. The non-volatile storage sub-module 561 does not lose data when power is removed and may be two orders of magnitude less costly than storage used in memory modules, at the expense of speed and latency. The non-volatile storage sub-module 561 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (561) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the aforementioned computing device 500 may employ the communication sub-module 562 as a subset of the I/O 560, which may be referred to by a person having ordinary skill in the art as at least one of, but not limited to, computer network, data network, and network. The network allows computing devices 500 to exchange data using connections, which may be known to a person having ordinary skill in the art as data links, between network nodes. The nodes comprise network computer devices 500 that originate, route, and terminate data. The nodes are identified by network addresses and can include a plurality of hosts consistent with the embodiments of a computing device 500. The aforementioned embodiments include, but not limited to personal computers, phones, servers, drones, and networking devices such as, but not limited to, hubs, switches, routers, modems, and firewalls.

Two nodes can be networked together, when one computing device 500 is able to exchange information with the other computing device 500, whether or not they have a direct connection with each other. The communication sub-module 562 supports a plurality of applications and services, such as, but not limited to World Wide Web (WWW), digital video and audio, shared use of application and storage computing devices 500, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g., TCP/IP, UDP, Internet Protocol version 5 [IPv5], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-IVision Multiple Access [CDMA], and Integrated Digital Enhanced Network [IDEN]).

The communication sub-module 562 may comprise a plurality of size, topology, traffic control mechanism and organizational intent. The communication sub-module 562 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Cellular systems embody technologies such as, but not limited to, 3G,5G (such as WiMax and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line and wireless communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 500 may employ the sensors sub-module 563 as a subset of the I/O 560. The sensors sub-module 563 comprises at least one of the devices, modules, and subsystems whose purpose is to detect events or changes in its environment and send the information to the computing device 500. Sensors are sensitive to the measured property, are not sensitive to any property not measured, but may be encountered in its application, and do not significantly influence the measured property. The sensors sub-module 563 may comprise a plurality of digital devices and analog devices, wherein if an analog device is used, an Analog to Digital (A-to-D) converter must be employed to interface the said device with the computing device 500. The sensors may be subject to a plurality of deviations that limit sensor accuracy. The sensors sub-module 563 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:

Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nano-sensors).

Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensor (guitar pickup), seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermos-luminescent dosimeter.
Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, LiDAR, multi-spectral light sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezo capacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 500 may employ the peripherals sub-module 562 as a subset of the I/O 560. The peripheral sub-module 565 comprises ancillary devices used to put information into and get information out of the computing device 500. There are 3 categories of devices comprising the peripheral sub-module 565, which exist based on their relationship with the computing device 500, input devices, output devices, and input/output devices. Input devices send at least one of data and instructions to the computing device 500. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to position of a mouse.
The number of degrees of freedom involved, such as, but not limited to, two-dimensional mice vs three-dimensional mice used for Computer-Aided Design (CAD) applications.

Output devices provide output from the computing device 500. Output devices convert electronically generated information into a form that can be presented to humans. Input/output devices that perform both input and output functions. It should be understood by a person having ordinary skill in the art that the ensuing are non-limiting embodiments of the aforementioned peripheral sub-module 565:

### Input Devices

Human Interface Devices (HID), such as, but not limited to, pointing device (e.g., mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
High degree of freedom devices, that require up to six degrees of freedom such as, but not limited to, camera gimbals, Cave Automatic Virtual Environment (CAVE), and virtual reality systems.
Video Input devices are used to digitize images or video from the outside world into the computing device 500. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
Audio input devices are used to capture sound. In some cases, an audio output device can be used as an input device, in order to capture produced sound. Audio input devices allow a user to send audio signals to the computing device 500 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrument Digital Interface (MIDI) devices such as, but not limited to a keyboard, and headset.
Data Acquisition (DAQ) devices convert at least one of analog signals and physical parameters to digital values for processing by the computing device 500. Examples of DAQ devices may include, but not limited to, Analog to Digital Converter (ADC), data logger, signal conditioning circuitry, multiplexer, and Time to Digital Converter (TDC).

Output Devices may further comprise, but not be limited to:
Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).

Printers, such as, but not limited to, inkjet printers, laser printers, 3D printers, solid ink printers and plotters.
Audio and Video (AV) devices, such as, but not limited to, speakers, headphones, amplifiers and lights, which include lamps, strobes, DJ lighting, stage lighting, architectural lighting, special effect lighting, and lasers.
Other devices such as Digital to Analog Converter (DAC)

Input/Output Devices may further comprise, but not be limited to, touchscreens, networking device (e.g., devices disclosed in network 562 sub-module), data storage device (non-volatile storage 561), facsimile (FAX), and graphics/sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A system for an automated real-time digital identity verification based on live biometric data, comprising:
a processor of an identity verification node connected to at least one verifier entity node over a network; and
a memory on which are stored machine-readable instructions that when executed by the processor, cause the processor to:
acquire a request associated with a user cryptograph embedded into an identification user credential from the at least one verifier entity node, wherein the identity verification request comprising at least one live biometric data sample captured by the at least one verifier entity node and at least one parameter indicating a piece of data from the user cryptograph to be revealed to the at least one verifier entity;
generate a stable bio-hash from the at least one live biometric data sample;
derive the at least one parameter from the request;
generate a decryption key comprising a plurality of shards from the at least one live biometric data sample; and
provide at least one of the plurality of shards to the at least one verifier entity node based on the at least one parameter.

2. The system of claim 1, wherein the instructions further cause the processor to provide the plurality of shards to decrypt the user cryptograph in its entirety.

3. The system of claim 1, wherein each of the plurality of shards corresponds to a designated biographic data piece encrypted within the user cryptograph.

4. The system of claim 3, wherein the instructions further cause the processor to provide a shard designated to a biometric template contained in the user cryptograph.

5. The system of claim 4, wherein the instructions further cause the processor to validate the biometric template contained in the user cryptograph against a pre-stored biometric template retrieved from a blockchain ledger.

6. The system of claim 5, wherein the instructions further cause the processor to, responsive to the validation of the biometric template, generate a plurality of decryption key shards based on a stable bio-hash of the validated biometric template.

7. The system of claim 6, wherein the biometric template represents biometrics of a different type from the at least one live biometric data sample.

8. The system of claim 1, wherein the instructions further cause the processor to record the at least one of the plurality of shards corresponding to the at least one parameter on the blockchain ledger.

9. The system of claim 8, wherein the instructions further cause the processor to retrieve the at least one of the plurality of shards from the blockchain ledger.

10. A method for an automated real-time digital identity verification based on based on live biometric data, comprising:
acquiring, by an identity verification (IV) node, a request associated with a user cryptograph embedded into an identification user credential from at least one verifier entity node, wherein the identity verification request comprising at least one live biometric data sample captured by the at least one verifier entity node and at least one parameter indicating a piece of data from the user cryptograph to be revealed to the at least one verifier entity;
generating, by the IV node, a stable bio-hash from the at least one live biometric data sample;
deriving, by the IV node, the at least one parameter from the request;
generating, by the IV node, a decryption key comprising a plurality of shards from the at least one live biometric data sample; and
providing, by the IV node, at least one of the plurality of shards to the at least one verifier entity node based on the at least one parameter.

11. The method of claim 10 further comprising providing the plurality of shards to decrypt the user cryptograph in its entirety.

12. The method of claim 10 further comprising providing a shard designated to a biometric template contained in the user cryptograph.

13. The method of claim 12, further comprising validating the biometric template contained in the user cryptograph against a pre-stored biometric template retrieved from a blockchain ledger.

14. The method of claim 13, further comprising, responsive to the validating of the biometric template, generating a plurality of decryption key shards based on a stable bio-hash of the validated biometric template.

15. The method of claim 10, further comprising recording the at least one of the plurality of shards corresponding to the at least one parameter on the blockchain ledger.

16. The method of claim 15, further comprising retrieving the at least one of the plurality of shards from the blockchain ledger.

17. A non-transitory computer-readable medium comprising instructions, that when read by a processor, cause the processor to perform:
acquiring a request associated with a user cryptograph embedded into an identification user credential from at least one verifier entity node, wherein the identity verification request comprising at least one live biometric data sample captured by the at least one verifier entity node and at least one parameter indicating a piece of data from the user cryptograph to be revealed to the at least one verifier entity;
generating a stable bio-hash from the at least one live biometric data sample;
deriving the at least one parameter from the request;
generating a decryption key comprising a plurality of shards from the at least one live biometric data sample; and
providing at least one of the plurality of shards to the at least one verifier entity node based on the at least one parameter.

18. The non-transitory computer readable medium of claim 17, further comprising the instructions, that when read by a processor, cause the processor to provide a shard designated to a biometric template contained in the user cryptograph.

19. The non-transitory computer readable medium of claim 18, further comprising the instructions, that when read by a processor, cause the processor to validate the biometric template contained in the user cryptograph against a pre-stored biometric template retrieved from a blockchain ledger.

20. The non-transitory computer readable medium of claim 19, further comprising the instructions, that when read by a processor, cause the processor to, responsive to the validation of the biometric template, generate a plurality of decryption key shards based on a stable bio-hash of the validated biometric template.
